(19) United States
(12) Patent Application Publication
(10) Pub. No.: US 2006/0119840 A1
(43) Pub. Date: Jun. 8, 2006

(54) Method for sensing and controlling radiation incident on substrate

(75) Inventors: Andrew J. Garcia, Lomita, CA (US); Anton G. Moldovan, Irvine, CA (US)

Correspondence Address: IRVING KESCHNER, 21535 HAWTHORNE BOULEVARD, SUITE 385, TORRANCE, CA, 90503, US

(73) Assignee: LIGHTWAVE ENERGY SYSTEMS CO., INC.

(21) Appl. No.: 11/007,676

(22) Filed: Dec. 8, 2004

(51) Int. Cl. G01J 1/00

(52) U.S. Cl. 356/213

(57) ABSTRACT

A system is disclosed that is using a high energy point like source illuminator comprising an ultraviolet source, where the source is being energized by a variable power supply that is controlled by a UV sensor and microprocessor. The energy from the illuminator is focused in the proximal end of a fiber optic light guide, a feed back branch coupling reflected light to the UV sensor. The light travels inside the guide and exits through its distal end first exposing a standard substrate. The standard substrate and a working substrate are positioned adjacent to each other and the UV light is first directed toward the standard substrate, the reflected light being incident on the sensor. The sensor output signal is then coupled to the microprocessor, which adjusts the power delivered to the bulb to correspond to the value established for the standard substrate, the microprocessor determining the needed exposure time to affect the cure. Thereafter, the incident light is redirected toward the working substrate, the reflected light therefrom being sensed, the microprocessor then adjusting the power supply such as to keep the bulb light intensity constant in accordance with the parameters established by the standard measurements.

### BACKGROUND OF THE INVENTION

1. Field of the Invention

The present invention provides a method for setting and controlling the energy emitted from a radiation source that is directed to a volume of material that is to be cured.

2. Description of the Prior Art

The concept of measuring and/or controlling the output from a source of radiation has been disclosed in the prior art.

For example, systems for controlling the intensity of the output radiation using a feedback arrangement are disclosed in U.S. Pat. Nos. 4,665,627, 5,418,369 and 6,400,444. Systems for controlling the intensity of the output radiation in an open loop mode is disclosed in U.S. Pat. Nos. 6,128,068 and 6,271,909 and systems that measure/control other properties of the radiation are disclosed in U.S. Pat. Nos. 4,848,539, 4,672,196, 4,849,640, 4,865,445, 4,913,859, 5,608,526, 5,958,271, 6,211,947, 6,217,695 and RE 37,740.

Referring specifically to the feedback related patents, the '627 patent describes a system wherein the radiation (UV light in this case) coming from the illumination source is captured by a sensor whose housing eliminates reflections. The sensor output is compared with a threshold and the error signal is communicated to a microprocessor. The microprocessor controls the power supply to the source thus compensating for source bulb aging and other mechanical deformations induced by heating or other factors.

U.S. Pat. No. 5,418,369 describes a system used to cure a coating material deposited on a moving optical fiber. The source is placed in one of focal points of an ellipse. The optical fiber travels to the ellipse's plane through the second focal point. Thus, all the radiation is captured and directed toward the fiber. The light intensity is monitored via several sensor positions and an average value obtained. This value is then used to adjust the amount of radiation energy used for curing the coating material.

U.S. Pat. No. 5,420,417 describes a photolithographic apparatus in which the UV light passing through a fly's eye lens structure constitutes the Fourier transform plane with respect to the circuit pattern on the standard reticule. This allows the incident angle to be determined and the amount of light emerging from these secondary sources is determined by sensors placed in a plane substantially equivalent to the pattern imaging plane meaning the same plane as the wafer, which is the illuminated object. The light intensity is modulated by a set of light attenuating systems.

U.S. Pat. No. 6,400,444 discloses a wafer exposure apparatus in which the UV light emitting lamp drive controls the light intensity according to the readings of a sensor. To extend the usable life of the UV source, a CPU controls a set of shutter and wafer carriage driving circuits. Thus, the light intensity during the exposure is kept constant, while, when the shutters are closed the current voltage or power are kept constant.

The systems noted hereinabove address certain aspects of radiation source control, either intensity or power or their dependence on the substrate material. However, they do not address one of the more important aspects of the state of the curing devices, i.e. the delivery of constant energy to a volume of curing material without the need to know the emissivities of the different curing materials. This energy density has to be kept constant regardless of the changes in the source due to aging or any other changes in the apparatus, processing environment of the process itself.

Again, although the above prior art systems provide certain distinct features, one of the disadvantages is that the radiation generated by the source can disperse to some degree before it reaches the material being cured thus not providing an accurate reading for control purposes. Similarly, the radiation reflected from the material surface may disperse and thus not provide an accurate sensor reading for control purposes. Most importantly, it is difficult to measure the amount of energy deposited in a volume directly under the surface of a material to be cured (and thus obtain an indication as to the success of the curing process) since the portion of the energy beam reflected depends on the nature and status of the surface of the material being cured. In a typical cycle, the user/customer may have a multitude of parts that have to be cured at precisely controlled exposure levels. Although measurement of surface emissivity could provide a parameter to measure the cure effectiveness, it is difficult to measure.

Thus, what is desired is to provide a method for accurately controlling the intensity of the radiation emitted by a source incident on a working surface to be cured regardless of the properties of the working surface and wherein the amount of energy deposited in a curing volume can be accurately controlled.

### SUMMARY OF THE PRESENT INVENTION

The present invention provides a dual mode, high-energy point source illuminator utilizing a reflector and an ultraviolet light source with a power source that accurately controls the intensity of the illumination emitted by the source and incident on a working surface. The radiation generated by the radiation source is used for curing a radiation curable material formed on the surface of a substrate. The source is energized by an adjustable power supply controlled by an optical sensor, the energy from the illuminator being focused and concentrated in the proximal end of a fiber optic light guide. The output end of the guide includes a first set of fibers dedicated to delivering the radiation to a surface and a second set of fibers the feedback bundle, for receiving radiation reflected from the coating material in its bundle. The feedback branch connects to the radiation sensor via a filter that blocks undesirable signals.

The light coming from the illuminator enters the guide by its proximal end and travels inside the guide until it exits from the first set of fibers. Once the light exits the distal end, the coating material exposed to the radiation reflects some energy depending on the curing material emissivity, or reflectivity.

A portion of the reflected light enters the second set of fibers arranged randomly or otherwise and located in the distal end of the guide and travels therewith to exit at the end of the feed back branch. The light from this end is filtered and fed to the sensor whose output signal is coupled to a microprocessor that controls the power supply output to the bulb.

The amount of signal reflected back from the part having the cure material formed thereon depends on the absorption/reflectance of the part and the curable material being processed. The present invention provides a technique that eliminates the need to know the properties of the cure material and enables the system to maintain the energy density deposited in the curing material substantially constant, correcting for changes in the system status such as bulb aging, variation in part surface emissitivity and others, thus controlling the amount of energy deposited in the curing volume to any degree of accuracy. The amount of exposure is monitored and controlled by adjusting the power to the bulb to compensate for changes in its output, and changes in the process end as well as monitoring the energy output from the guide.

Specifically, the system has two operating modes; the first, or constant intensity mode, controls the bulb output based on the bulb characteristics and a second, or constant power mode, takes into account the properties of the working surface, such as emissitivity which impacts the energy reflected thereby. In the second, or constant power mode, a target, or working, substrate and a standard calibrated substrate are positioned in a predetermined relationship to each other. Prior to directing the radiation, preferably UV radiation, towards the working substrate, the fiber bundle is positioned adjacent the standard substrate. The radiation reflected from the standard substrate travels through the second set of fibers and is incident on an optical sensor. The signal generated by the sensor in response to the incident radiation is then directed to the microprocessor, which processes the signal corresponding to the emissitivity value established for the standard substrate. The microprocessor is programmed to calculate, in response to the stored signal, the needed exposure to affect the cure at the working substrate. It should be noted that the power emitted by a source decays as the square of the distance it travels. Thus, to properly control the power delivered to the substrate, the distance from the end of the fiber and the substrate must be maintained constant. This is accomplished by using a proximity sensor, a mechanical stop or other distance controlling mechanism or process. After this operation, the fiber is redirected toward the working substrate. The light reflected from the working substrate is detected by the second set of fibers and directed to the server, measured and the control value is normalized to the value measured on the standard substrate. The microprocessor then adjusts the power supply such as to keep the radiation intensity equivalent to that necessary to provide the same relative irradiance from the working substrate as that measured from the standard substrate based on the calibration step. At this point the calibration is complete and the microprocessor switches the operating mode to constant power monitoring in real time every exposure cycle thereafter by using the feedback sensor normalized signal. After a predetermined number of parts have been cured, the microprocessor switches the system to the constant intensity mode for re-calibration, the switching process being repeated in a cycled manner.

This technique eliminates the need to know the emissitivity properties of the cure material by simply using voltage ratios or the ratio of any measurable quantities and enables the apparatus to maintain the bulb output constant, correcting for all curing system changes. Thus, the amount of energy deposited in the curing volume is determined and accurately controlled.

### DESCRIPTION OF THE DRAWING

For a better understanding of the present invention as well as other objects and further features thereof, reference is made to the following description which is to be read in conjunction with the accompanying drawing wherein:

FIG. 1 is a block diagram of the present invention in a first mode of operation;

FIG. 2 is a block diagram of the present invention in a second mode of operation; and

FIG. 3 is a flow chart illustrating the calibration sequence utilized in the present invention.

### DESCRIPTION OF THE INVENTION

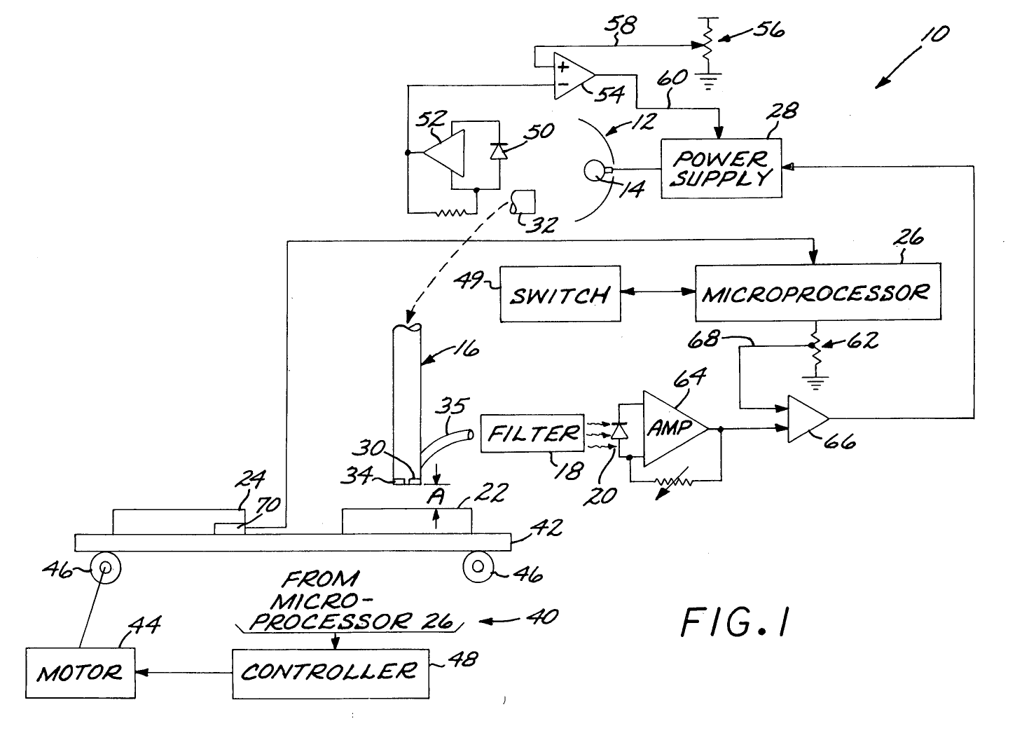

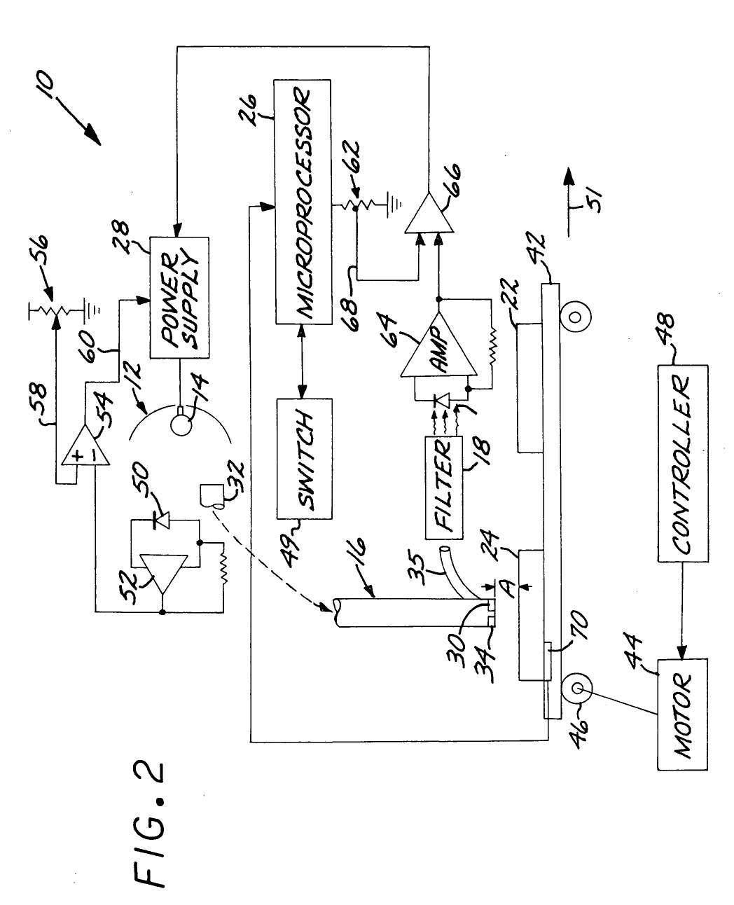

Referring now to the Figure, the system 10 of the present invention is illustrated in the first, or operating, mode of operation. The components labeled with the same reference numerals in FIGS. 1 and 2 identify identical components. In this example, a UV source or radiation is utilized. However the present invention can be utilized with any other type of radiation field and source.

The basic components of system 10 comprise of a point source U.V. illuminator 12 having a UV source 14 at the focal point of illuminator 12, fiber optic light guide 16, filter 18, feedback sensor diode 20, working substrate 22, standard substrate 24, microprocessor 26 and power supply 28.

The fiber optic light guide 16 comprises a distal (output) end 30, a proximal (input) end 32 and a sensing, or feedback, branch 34.

The UV source 14 is energized by power supply 28, which in turn is controlled by sensor 20.

The energy from the illuminator 12 is focused and concentrated in the proximal (input) end 32 of the fiber optic light guide 16. The guide 16 has a feed back branch 34 that contains extra fibers. The feed back branch connects to the UV sensor 20 via optical filter 18; filter 18 blocking all undesirable optical signals.

The light coming from the illuminator 12 enters the guide 16 by its proximal end 32 and travels inside the guide 16 until it exits through its distal end 30 where there are a percentage of fibers randomly located in the core bundle. Once the light exits the distal end 30, the exposed substrate reflects some energy depending on its reflectivity and the curing material emissitivity, or reflectivity.

Part of the reflected light enters the extra feed back fibers 34 randomly located in the distal end 30 of guide 16 and travels within them to exit through the feed back branch 35. The light from this end is filtered by filter 18 to reject undesirable signals and is then fed into the UV sensor 20 that controls adjustable power supply 28 which in turn provides an output to the bulb 14.

The amount of signal reflected back from the substrate 22 having the cure material thereon will depend on its relative distance A between the surface of the substrate 22 and the distal end 30 and the absorption/reflectance of the curable material being processed. The present invention monitors the amount of exposure, adjusting the power to the bulb 14 to compensate for changes in its output due to bulb aging and changes in the process end (i.e. part location, substrate change, deposits in the distal end 30 of the guide, etc.). A proximity sensor or mechanical stop (not shown) is utilized to maintain distance A constant.

To take into account the fact that the properties of the working surface, specifically the emissitivity of the material to be cured, a standard calibrated substrate 24 is positioned adjacent to the target substrate 22. Prior to directing the UV light toward the working substrate 22, control apparatus 40 (FIG. 2) automatically positions the fiber bundle 16 adjacent the standard substrate 24 via motor 44 and wheels 46 or any equivalent structure (alternatively, the substrates 22 and 24 may be maintained in a fixed position and fiber bundle 16 moved relative thereto). The reflected UV light traveling through the selected fibers will fall on a sensor 20. The detected signal is then directed to the microprocessor 26, which adjusts the power delivered to the bulb 14 to correspond to the value established for the standard substrate 24. The microprocessor 26 then calculates the needed exposure time to affect the cure in the surface material on working substrate 22. A microprocessor that has been successfully utilized and programmed accordingly is selected from the Motorola 8051 family type (other microprocessors could be utilized). After these operations, the radiation emitted from fiber bundle 16 is redirected toward the working substrate 22 as motor 44, controlled by controller 48, causes platform 42 to move in the direction indicated by the arrow 51, thus positioning target substrate 22 under distal end 30, (FIG. 1). The reflected light coming back through fiber optic guide 16 and the proximal end 34 thereof is directed to the sensor 20 via filter 18 and is measured. The control value will be normalized to the value measured on the standard substrate 24 by microprocessor 26 which then adjusts the power supply 28 such as to keep the UV light intensity constant.

This procedure eliminates the need to know the properties of the working substrate 22 and enables the apparatus to maintain the output of bulb 14 constant both in the short run and in the long run. At the same time, the amount of energy deposited in the curing volume can be determined and controlled to any degree of accuracy.

Referring again to the Figures, the features of the present invention are set forth hereinafter in more detail utilizing a specific electrical/mechanical design. It should be noted that other equivalent designs can also be utilized.

In particular, in order to take into account the specific needs of a customer, the system of the present invention has two operating modes and a calibration mode. The first operating mode is a constant intensity mode that, in essence, tracks the intensity of the illumination emitted from bulb 14 as time progresses and is used to eliminate the dependence of the process parameters on the substrate's surface optical properties. The second operating mode is a constant power mode that takes into account aspects of the curing process itself at target substrate 22.

When system 10 is first powered up, microprocessor 26 activates switch 49 such that system 10 is in the constant intensity mode. In this mode, optical diode sensor 50 senses the illumination output from bulb 14 and generates an electrical signal in response; this signal is then amplified by amplifier 52. As the light source ages, the bulb light output intensity decreases, decreasing the output of diode 50 and the output from amplifier 52. The output from amplifier 52 is coupled to one input of differential amplifier 54, the other input to amplifier 54 being coupled to adjustable potentiometer 56, the output of which establishes the desired voltage signal applied to power supply 28. The result is that the output signal from amplifier 54 and applied to lead 60 is of a magnitude to cause the output of power supply 28 to increase, this in turn increasing the power to bulb 14 and causing bulb 14 to generate additional light output. It should be noted that the range of the control parameter applied to bulb source 14 is limited to the extent that it is within the operating characteristics of the source in a manner such that the source will not breakdown.

After the constant intensity mode of operation is completed, switch 49 is activated causing microprocessor 26 to switch system 10 to the constant power mode. The importance of this mode is to take into account the fact that the properties of the working surface impact the energy reflected thereby and thus necessitates further measurement and control of the amount of UV energy directed to the working surface of substrate 22, most importantly, to cure parts to the degree and accuracy requested by the user/customer.

Prior to entering the second operating mode, microprocessor 26 causes fiber optic light guide 16 to be initially positioned over standard substrate, or customer part 24 (FIG. 2). The illumination generated by bulb 14 and reflected from standard substrate 24 is measured by radiometer etalon 70 and coupled to microprocessor 26. Microprocessor 26 then processes this value as representing the emissivity of the parts to be cured at working substrate 22. This voltage is the reference voltage applied to potentiometer 62. Microprocessor 26 then causes controller 48 to move table 42 such that fiber optic light guide 16 is positioned over the working substrate 22 (FIG. 1) and the curing process/constant intensity mode initiated via light delivery fiber optic bundles 30.

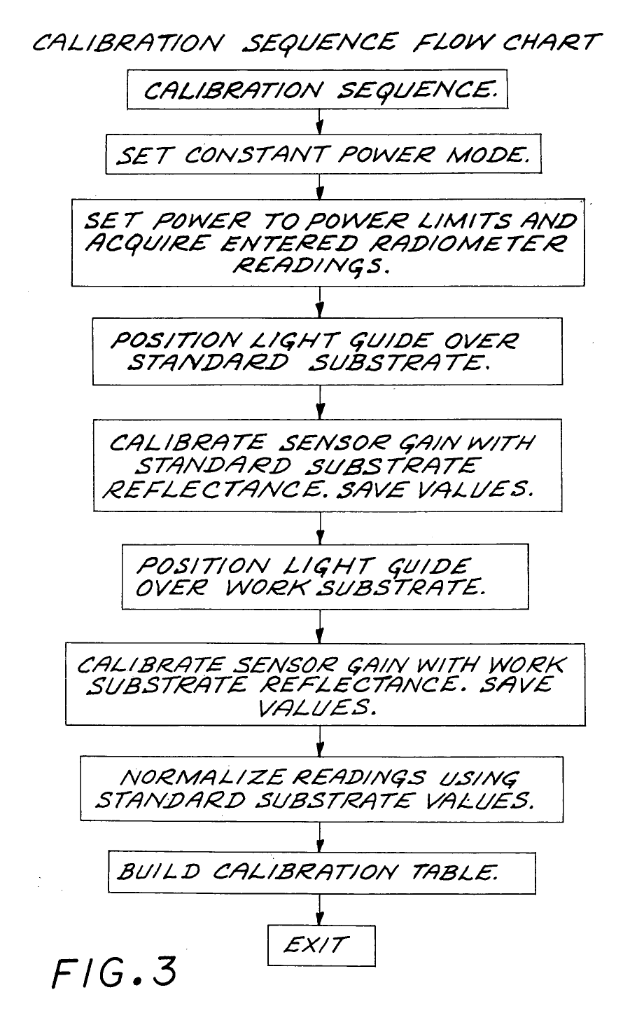

A flow chart of the system calibration operation is described hereinafter with reference to FIG. 3 and a more detailed description of the system operation follows.

System 10 first calibrates the source 14 via the use of radiometer etalon 70. Then the calibrated source is used to measure the standard substrate 24 and establish a value for its emissivity. Thus the standard substrate 24 functions as a proxy for the radiometer in all other functions of the curing system. Further, system 10 performs time dependent measurements of the emissivity of standard substrate 24. These values are used by microprocessor 26 to provide the necessary information to the process control software in microprocessor 26 to maintain the curing process within the boundaries of the process; the information is also used in statistical process control as needed.

Specifically, prior to the start of the process the system calibrates source 14 using the standard substrate 24. Next the emissivity of the working substrate 22 is measured. With this information, the microprocessor 26 calculates the power reflected by the working substrate 22. The measurement is made via the small fiber bundle 35 that directs the reflected radiation to the detector 20. This value is used to ultimately calculate the power absorbed by the working substrate 22 which is the value needed for the process control.

As previously mentioned, the distance A, between the end of the fiber 30 and the working substrate 22 is maintained constant. To achieve this goal a proximity sensor or mechanical stop is placed on the fixture holding the fiber (not shown).

The algorithm used to calculate the power reflected by working substrate 22 is calculated as follows. The power incident on the surface of the standard substrate 24 and working substrate 22 is designated by Ps and Pw, respectively. In addition, both the absorbed and reflected power by the surfaces of the standard and working substrates are designated by Ps,abs, Ps,refl, Pw,abs and Pw,refl, resulting in the following relationships:
Ps=Ps,abs+Ps,refl
Ps,refl=εs*Ps

Where εs is the emissivity of the standard substrate. A similar set of equations is also set forth for the working stubstrate. Thus,
Ps,abs/w,abs=(1/εs,w−1)*Ps/w
PS,refl/w,refl=(1/εs,w)*Ps/W
And ultimately:
Pw,abs=(1/(εw*Ps,refl/Pw,refl)−1)*Pw,refl

This relationship gives the power absorbed by the working surface and available for cure as a function of the measured and controllable quantity, Pw,refl.

Once the initial calibration of the curing process is finished, the curing process is started. The function of system 10 is now to maintain the power absorbed by the working substrate 22 constant within the process boundaries and measurements accuracies. To accomplish this task, system 10 continuously monitors the power reflected from the surface of working substrate 22. The parameters measured by the detector are used by the microprocessor 26 to control the source power supply 28. Consequently, the power, and implicitly the energy density, that reaches the surface of working substrate 22 is kept constant per the process requirements. These measurements are not significantly affected by the changes in optics due to the curing process byproducts since both delivery and measurement fiber ends will see the same changes. However, during the calibration process and control process these changes can be detected and recorded.

While the invention has been described with reference to its preferred embodiments, it will be understood by those skilled in the art that various changes may be considered or implemented and equivalents may be substituted for elements thereof without departing from the true spirit and scope of the invention. In addition, many modifications may be made to the exact implementation of the calibration and control process to adapt a particular situation or material to the teachings of the invention without department from its essential teachings. In particular, the present invention can be adapted, for example, not only to a system based on fiber, but also to a system based on free space propagation of the UV light or any other radiation field.

What is claimed is:

1. A method for measuring the power of radiation that reaches a working surface measured proximally to that surface and in real time; said working surface being cured by said radiation comprising the steps of:
providing a source of radiation;
directing the radiation generated by said radiation source to said surface utilizing a first portion of an optical fiber bundle;
returning a portion of the radiation reflected by said working surface via said first optical fiber bundle portion to a measuring device which generates an output signal; and
utilizing said output signal to control said radiation source.

2. The method of claim 1 wherein said portion of said radiation irradiates a substrate having a first surface of a predetermined emissivity, the light reflected from said first surface being measured and then utilized to calibrate said radiation source.

3. The method of claim 2 wherein said light reflected from said first surface determines the amount of radiation power absorbed by said working surface.

4. A method for measuring the power of radiation that is incident on working surface measured proximally to that surface and in real time, said working surface being cured by said radiation comprising the steps of:
providing a standard substrate having a first surface of a predetermined emissivity;
directing said radiation to said first surface in a first mode of operation, the radiation reflected from said first surface being measured and a first signal being generated in response to said measurement;
calibrating a circuit in response to said first signal;
directing said radiation to said first surface in a second mode of operation and returning a portion of the radiation reflected by said working surface to a measuring device which generates a first output signal in response to said returned portion of the radiation;
comparing said first output signal with said first signal and generating an adjustment signal proportional to the difference therebetween; and
coupling said adjustment signal to a source of power to produce a second output signal, said second output signal being coupled to said source of radiation.

5. The method of claim 4 wherein the output of said radiation source is measured in a third mode of operation to generate a third output signal, said third output signal being coupled to said power source.

6. The method of claim 5 wherein said radiation is UV.
